(19) United States
(12) Patent Application Publication
(10) Pub. No.: US 2026/0238253 A1
(43) Pub. Date: Aug. 13, 2026

(54) FREQUENCY HOPPING CONFIGURATION VIA BWP

(71) Applicant: TELEFONAKTIEBOLAGET LM ERICSSON (PUBL), STOCKHOLM (SE)

(72) Inventors: Florent Munier, Västra Frölunda (SE); Zhilan Xiong, Solna (SE); Chunhui Zhang, Stockholm (SE); Deep Shrestha, Linköping (SE)

(21) Appl. No.: 19/157,659

(22) PCT Filed: Feb. 19, 2024
(86) PCT No.: PCT/IB2024/051570

§ 371 Date: Aug. 18, 2025

Related U.S. Application Data
(60) Provisional application No. 63/446,724, filed on Feb. 17, 2023.

(51) Int. Cl. H04B 1/713; H04L 27/26

(52) U.S. Cl. CPC H04B 1/713; H04L 27/261

(57) ABSTRACT

Various embodiments provide for methods for signaling to Reduced Capability (RedCap) User Equipment devices (UEs) to perform frequency hopping using a bandwidth part (BWP) framework. The methods can include using new parameters to signal the frequency hopping, and also to distinguish between paired and unpaired spectrum. In one embodiment, a RedCap UE could be configured with a BWP not any wider than its radio frequency (RE) bandwidth BW for Sounding Resource Signal (SRS)/positioning reference signal (PRS) frequency hopping. In such a case, new parameters could be defined to be associated with the RB allocation for each frequency hop.

### RELATED APPLICATIONS

This application claims the benefit of provisional patent application Ser. No. 63/446,724, filed Feb. 17, 2023, the disclosure of which is hereby incorporated herein by reference in its entirety.

### TECHNICAL FIELD

The present disclosure relates to Reduced Capability (RedCap) User Equipment (UE) configuration of frequency hopping within a Bandwidth Part (BWP) framework in a wireless communication system.

### BACKGROUND

New Radio (NR) positioning Rel-18 with the potential enhancements for Reduced Capability (RedCap) device positioning in which the maximal bandwidth of the RedCap user equipment (UE) is 20 MHz in Frequency Range 1 (FR1) and 100 MHz in FR2. One of the target enhancements is to introduce positioning reference signal (PRS)/sounding reference signal (SRS) frequency hopping for the positioning accuracy improvement of downlink-related RedCap positioning.

### SUMMARY

Various embodiments provide for methods for signaling to Reduced Capability (RedCap) User Equipment devices (UEs) to perform frequency hopping using a bandwidth part (BWP) framework. The methods can include using new parameters to signal the frequency hopping, and also to distinguish between paired and unpaired spectrum. In one embodiment, a RedCap UE could be configured with a BWP not any wider than its radio frequency (RF) bandwidth BW for Sounding Resource Signal (SRS)/positioning reference signal (PRS) frequency hopping. In such a case, new parameters could be defined to be associated the RB allocation for each frequency hop.

In an embodiment, a method can be performed by a RedCap UE for configuring frequency hopping via a BWP framework, the method including receiving (402), from a network node (510), a sounding reference signal, SRS, parameter with a resource block allocation for at least one frequency hop of a plurality of frequency hops and performing (404) a frequency hop based on the SRS parameter.

In an embodiment, a BWP of the RedCap UE is a same size or smaller than a radio frequency bandwidth of the RedCap UE.

In an embodiment, the SRS parameter indicates a center frequency for the at least one frequency hop.

In an embodiment, the center frequency of the at least one frequency hop is within the BWP of the RedCap UE.

In an embodiment, a BWP of the RedCap UE is larger than a radio frequency bandwidth of the RedCap UE.

In an embodiment, the SRS parameter indicates a center frequency for the at least one frequency hop.

In an embodiment, a center frequency of the resource block allocation is predefined.

In an embodiment, a center frequency of the resource block allocation is based on an offset parameter associated with the SRS parameter.

In an embodiment, uplink frequency hopping and downlink frequency hopping are configured separately.

In an embodiment, uplink frequency hopping and downlink frequency hopping are configured together.

In an embodiment, the SRS parameter is received via at least one of Radio Resource Control (RRC) signaling, or via a Medium Access Control (MAC) entity.

In an embodiment, a RedCap UE can be configured for frequency hopping via a bandwidth part framework, where the RedCap UE includes processing circuitry configured to receive, from a network node, a SRS parameter with a resource block allocation for at least one frequency hop of a plurality of frequency hops and perform a frequency hop based on the SRS parameter.

In an embodiment, a method can be provided that is performed by a network node for configuring frequency hopping via a BWP framework. The method can include transmitting, to a RedCap UE, a SRS parameter with a resource block allocation for at least one frequency hop of a plurality of frequency hops.

In an embodiment, a network node for configuring for frequency hopping via a bandwidth part framework can be provided where network node includes processing circuitry configured to transmit, to a RedCap UE, a SRS parameter with a resource block allocation for at least one frequency hop of a plurality of frequency hops.

In an embodiment, a computer-readable medium can be provided that stores computer-executable instructions, that when executed by a processor, cause the processor to implement a method according to any one of the above embodiments.

Certain embodiments may provide one or more of the following technical advantage. RedCap UE frequency hopping can be configured within the BWP framework.

The RRC and MAC entity could be used for frequency hopping and with some modification on parameters, such that each frequency hop is associated with different BWPs.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is an illustration depicting frequency hopping with a wider Bandwidth Part (BWP) than a User Equipment device (UE) Radio Frequency (RF) bandwidth according to one or more embodiments of the present disclosure;

FIG. 2 is an illustration depicting frequency hopping with BWP not wider than a UE RF bandwidth in accordance with various aspects described herein;

FIG. 3 is an illustration depicting a relationship between center frequencies and overlapping BWPs in accordance with various aspects described herein;

FIG. 4 is a message sequence chart of a method for signaling to Reduced Capability (RedCap) UEs to perform frequency hopping using a BWP framework in accordance with various aspects described herein;

FIG. 5 shows an example of a communication system in accordance with various aspects described herein;

FIG. 6 shows a UE in accordance with various aspects described herein;

FIG. 7 shows a network node in accordance with various aspects described herein;

FIG. 8 is a block diagram of a host, in accordance with various aspects described herein;

FIG. 9 is a block diagram illustrating a virtualization environment in accordance with various aspects described herein; and

FIG. 10 shows a communication diagram of a host in accordance with various aspects described herein.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenges in achieving this goal. For example, there is no frequency hopping introduced to RedCap UE wider than its radio frequency (RF) bandwidth. There are still questions regarding how frequency hopping should be configured with the bandwidth part (BWP) framework.

Currently, BWP switching can be only trigged with the following mechanisms:
By PDCCH (i.e., DCI): A specific BWP can be activated by Bandwidth part indicator in DCI Format 0_1 (a UL Grant)
By the bwp-Inactivity Timer
By RRC signalling
By the MAC entity itself upon initiation of Random Access procedure

It is an open question how to use the current BWP switching mechanism to indicate a frequency hopping pattern to the UE.

Certain aspects of the disclosure and their embodiments may provide solutions to these or other challenges. This disclosure proposes techniques to configure the frequency hopping via BWP framework for RedCap UE frequency hopping. This solution introduces certain parameters of different BWPs associated with different frequency hops and differentiates the configuration for either paired or unpaired spectrum.

Certain embodiments may provide one or more of the following technical advantage. RedCap UE frequency hopping can be configured within the BWP framework.

The RRC and MAC entity could be used for frequency hopping and with some modification on parameters, such that each frequency hop is associated with different BWPs.

Various embodiments provide for methods for signaling to Reduced Capability (RedCap) User Equipment devices (UEs) to perform frequency hopping using a bandwidth part (BWP) framework. The methods can include using new parameters to signal the frequency hopping, and also to distinguish between paired and unpaired spectrum. In one embodiment, a RedCap UE could be configured with a BWP not any wider than its radio frequency (RF) bandwidth BW for Sounding Resource Signal (SRS)/positioning reference signal (PRS) frequency hopping. In such a case, new parameters could be defined to be associated the RB allocation for each frequency hop.

In one disclosed embodiment, a RedCap UE is configured with a wider BWP than its RF bandwidth BW for SRS/PRS frequency hopping. In such a case, new parameters may be defined to be associated with RB allocation for each frequency hop. One of the parameters may relate to the center frequency location of the RedCap UE RF bandwidth, for example, the local oscillator frequency. For another example, the center frequency location of a RedCap UE can be chosen by the UE using the center frequency of an allocated RB range within a frequency hop. Another example is to repurpose the existing OffsetToCarrier parameter and associate this parameter within one BWP or a different BWP configuration for each frequency hop. In such a case, the RedCap UE carrier bandwidth may be chosen to be 20 MHz by default, but other bandwidths may be utilized in other embodiments.

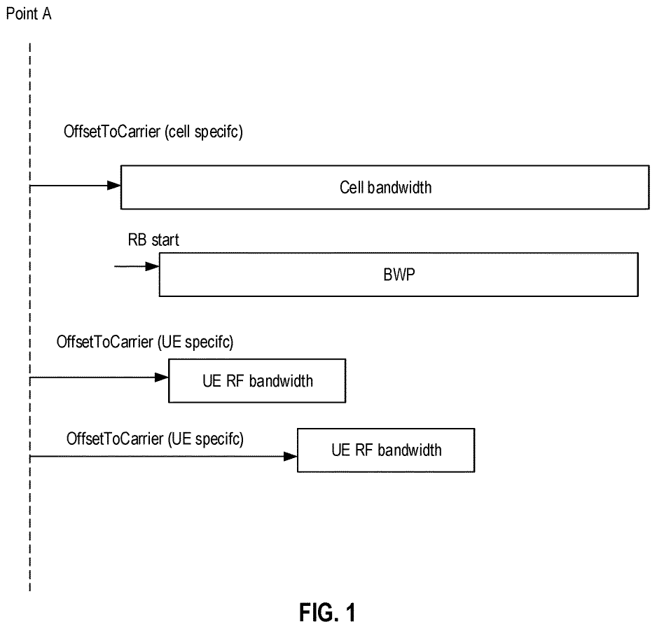

FIG. 1 depicts such an embodiment with frequency hopping with a wider BWP than UE RF bandwidth.

In another embodiment, a RedCap UE can be configured with a BWP that is not wider than its RF bandwidth BW for SRS/PRS frequency hopping. In such a case, new parameters may be defined to be associated with the RB allocation for each frequency hop. In such a case, there may be ambiguity regarding where to set the center frequency of each hop. In one example, each hop can still be set using the OffsetToCarrier. In other examples, the RedCap UE can set the center frequency itself, as long as the UE can transmit the scheduled SRS within the BWP.

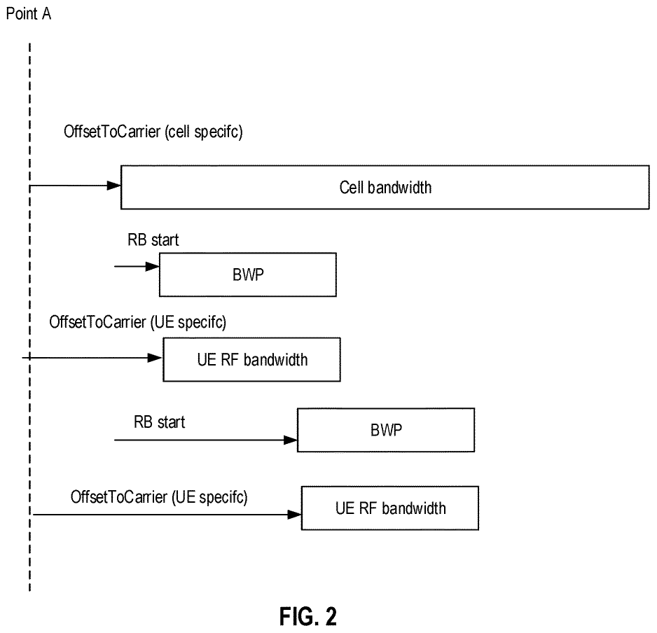

FIG. 2 depicts such an embodiment with frequency hopping within a BWP that is not wider than UE RF bandwidth.

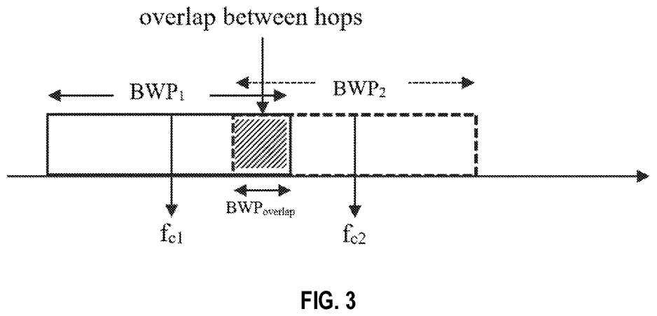

In yet another embodiment, a new parameter or parameters may be associated with the RB allocation for each frequency hop, the selection of center frequency of an allocated RB range within a frequency hop, and usage of OffsetToCarrier parameter to identify center frequency for next hop could be done, as shown in FIG. 3. In FIG. 3, fc₁ is the center frequency of the first BWP and fc₂ is the center frequency of the second BWP/second hop. The BWPₒᵥₑᵣₗₐₚ in FIG. 3 indicates overlap between the first BWP (BWP 1) and the second BWP (BWP 2). In this example scenario, fc₂ is equal to (fc₁+BWP₁/2−BWPₒᵥₑᵣₗₐₚ)+BWP₂/2.

Accordingly, FIG. 3 depicts the relationship between fc2 with respect to fc1 and BWPₒᵥₑᵣₗₐₚ.

In another embodiment, as for paired spectrum, the DL and UL BWP are configured and switched separately. For UL SRS frequency hopping, the frequency hopping configuration can be focused on UL BWP only. For unpaired spectrum, the DL and UL BWP are linked and switched together. So in some embodiments requiring a CSS configured also, both DL and UL BWP is configured for unpaired spectrum for frequency hopping configuration.

In another embodiment, when a RedCap UE is configured with a frequency hopping pattern, the network should reserve resources accordingly. To reduce the scheduler complexity, the frequency hops duration should be kept short, taking in to account the overhead of frequency retuning. However, a RedCap UE is expected to be synchronized to the DL frame timing and keep track of the cell timing. This is because during the frequency hop for each SRS transmission, the UE still needs to meet the frequency error requirement (e.g., 0.1 ppm) and also maintain the timing of UL frame boundary without a new update on the timing advance for each hop. For the paired spectrum, if there is no change on DL BWP, the UE keeps tracking of the cell timing. For the unpaired spectrum, as DL and UL BWP are switched together and if there is no CSI-RS or SSB with the DL BWP to which RedCap switched, the UE may lose the cell timing. To compensate for this, an additional time gap may be added between the frequency hops for the UE to re-sync to the cell timing for an unpaired spectrum. This may apply to a RedCap UE operating at HD-FDD mode also.

In another example, frequency hopping needs to be considered with a time gap between two hops and the UE will utilize this time gap for DL cell timing re-sync. For another example, for unpaired spectrum, an additional interruption time is allowed for DL cell re-sync and such interruption time may be associated with a slot boundary start to be started and ended. In another example, the UE does not update its AGC setting when receiving PRS resources in different hops. In this scenario, additional time for the AGC update is not considered. For another example, the UE determines a need to update its AGC setting when receiving PRS resources in different hops. In this scenario, an additional time required by UE to update its AGC setting needs to be accounted for. For one example, UE may be configured with frequency hopping for PRS measurements from different TRP. Such additional time may be needed if PRS measured in one slot/symbol is transmitted from one TRP and PRS measured in another slot/symbol is transmitted from another TRP.

For another embodiment, a UE is configured with PRS frequency hopping across one wideband where the bandwidth of one hop is the same as the bandwidth of each DL BWP configured to this UE. During the PRS frequency hopping, the resources used for the current hop are treated as an active virtual DL BWP, and the network uses the active virtual BWP for downlink transmission and the UE uses the active virtual BWP for downlink reception.

For another embodiment, one UE is configured with SRS frequency hopping across one wide bandwidth where the bandwidth of one hop is same as the bandwidth of each UL BWP configured to this UE. During the SRS frequency hopping, the resources used for the current hop are treated as an virtual active UL BWP, the UE uses the virtual active UL BWP for uplink transmission, and the network uses the virtual active UL BWP for uplink reception.

For some embodiments, the frequency hopping pattern is configured with RRC signaling or using MAC entity.

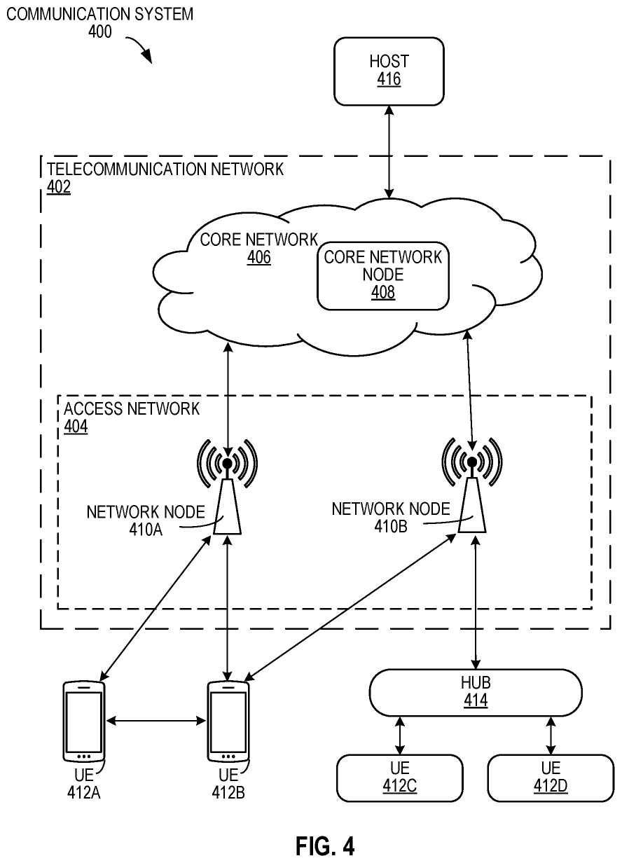

FIG. 4 is a message sequence chart of a method for signaling to Reduced Capability (RedCap) UEs to perform frequency hopping using a BWP framework in accordance with various aspects described herein.

At step 402, the network node 510 can provide an SRS parameter with a resource block allocation to a RedCap UE 512.

At step 404, the RedCap UE 512 can perform frequency hopping based on the SRS parameter and the resource block allocation.

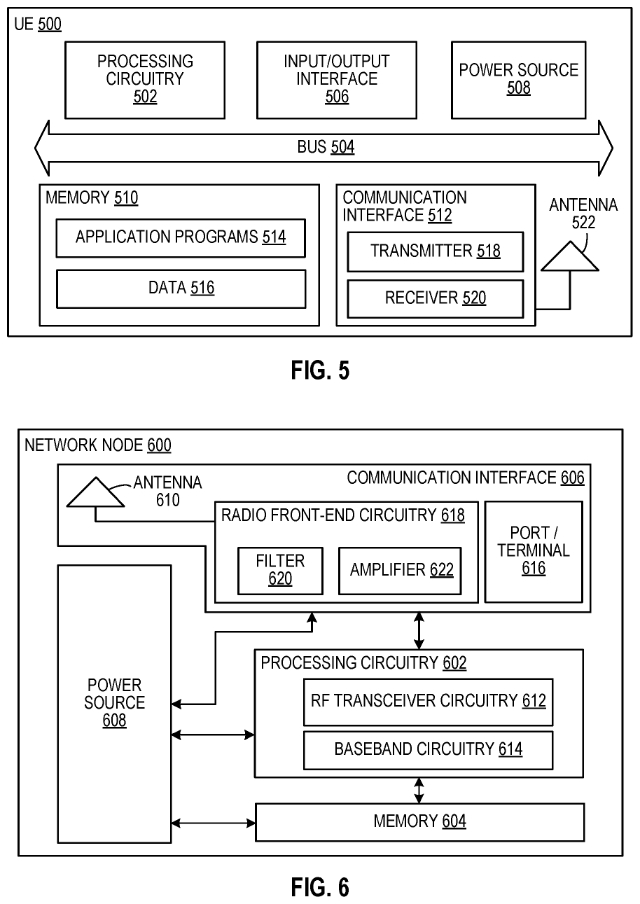

FIG. 5 shows an example of a communication system 500 in accordance with some embodiments.

In the example, the communication system 500 includes a telecommunication network 502 that includes an access network 504, such as a radio access network (RAN), and a core network 506, which includes one or more core network nodes 508. The access network 504 includes one or more access network nodes, such as network nodes 510a and 510b (one or more of which may be generally referred to as network nodes 510), or any other similar 3^{rd} Generation Partnership Project (3GPP) access node or non-3GPP access point. The network nodes 510 facilitate direct or indirect connection of user equipment (UE), such as by connecting UEs 512a, 512b, 512c, and 512d (one or more of which may be generally referred to as UEs 512) to the core network 506 over one or more wireless connections. One or more of the UEs 512 may be an embodiment of a RedCap UE as described herein.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 5G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 502 is a cellular network that implements 3GPP standardized features. Accordingly, the telecommunications network 502 may support network slicing to provide different logical networks to different devices that are connected to the telecommunication network 502. For example, the telecommunications network 502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 514 communicates with the access network 504 to facilitate indirect communication between one or more UEs (e.g., UE 512c and/or 512d) and network nodes (e.g., network node 510b). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a VR headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular if one or more of the UEs are low energy IoT devices.

The hub 514 may have a constant/persistent or intermittent connection to the network node 510b. The hub 514 may also allow for a different communication scheme and/or schedule between the hub 514 and UEs (e.g., UE 512c and/or 512d), and between the hub 514 and the core network 506. In other examples, the hub 514 is connected to the core network 506 and/or one or more UEs via a wired connection. Moreover, the hub 514 may be configured to connect to an M2M service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub—that is, a hub whose primary function is to route communications to/from the UEs from/to the network node 510b. In other embodiments, the hub 514 may be a non-dedicated hub—that is, a device which is capable of operating to route communications between the UEs and network node 510b, but which is additionally capable of operating as a communication start and/or end point for certain data channels.

FIG. 6 shows a UE 600 in accordance with some embodiments of RedCap UEs as described herein. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, a memory 610, a communication interface 612, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 602 may include multiple central processing units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging of the power source 608. Power circuitry may perform any formatting, converting, or other modification to the power from the power source 608 to make the power suitable for the respective components of the UE 600 to which power is supplied.

The memory 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 610 may allow the UE 600 to access instructions, application programs and the like, stored on transitory or non-transitory memory media, to off-load data, or to upload data. An article of manufacture, such as one utilizing a communication system may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., antenna 622) and may share circuit components, software or firmware, or alternatively be implemented separately.

In the illustrated embodiment, communication functions of the communication interface 612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 6.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

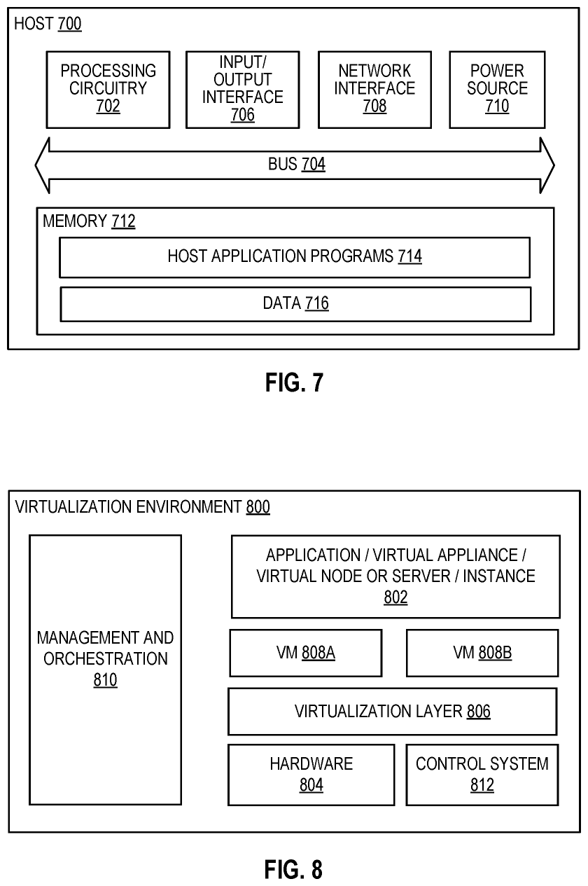

FIG. 7 shows a network node 700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes a processing circuitry 702, a memory 704, a communication interface 706, and a power source 708. The network node 700 may be composed of multiple physically separate components (e.g., a NodeB component and a RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 700 may be configured to support multiple radio access technologies (RATs). In such embodiments, some components may be duplicated (e.g., separate memory 704 for different RATs) and some components may be reused (e.g., a same antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 700.

The processing circuitry 702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 700 components, such as the memory 704, to provide network node 700 functionality.

In some embodiments, the processing circuitry 702 includes a system on a chip (SOC). In some embodiments, the processing circuitry 702 includes one or more of radio frequency (RF) transceiver circuitry 712 and baseband processing circuitry 714. In some embodiments, the radio frequency (RF) transceiver circuitry 712 and the baseband processing circuitry 714 may be on separate chips (or sets of chips), boards, or units, such as radio units and digital units. In alternative embodiments, part or all of RF transceiver circuitry 712 and baseband processing circuitry 714 may be on the same chip or set of chips, boards, or units.

The memory 704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and memory 704 is integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. Radio front-end circuitry 718 comprises filters 720 and amplifiers 722. The radio front-end circuitry 718 may be connected to an antenna 710 and processing circuitry 702. The radio front-end circuitry may be configured to condition signals communicated between antenna 710 and processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of filters 720 and/or amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface may comprise different components and/or different combinations of components.

In certain alternative embodiments, the network node 700 does not include separate radio front-end circuitry 718, instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes one or more ports or terminals 716, the radio front-end circuitry 718, and the RF transceiver circuitry 712, as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, communication interface 706, and/or the processing circuitry 702 may be configured to perform any receiving operations and/or certain obtaining operations described herein as being performed by the network node. Any information, data and/or signals may be received from a UE, another network node and/or any other network equipment. Similarly, the antenna 710, the communication interface 706, and/or the processing circuitry 702 may be configured to perform any transmitting operations described herein as being performed by the network node. Any information, data and/or signals may be transmitted to a UE, another network node and/or any other network equipment.

The power source 708 provides power to the various components of network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid, an electricity outlet) via an input circuitry or interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

FIG. 8 is a block diagram of a host 800, which may be an embodiment of the host 516 of FIG. 5, in accordance with various aspects described herein. As used herein, the host 800 may be or comprise various combinations hardware and/or software, including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and a memory 812. Other components may be included in other embodiments. Features of these components may be substantially similar to those described with respect to the devices of previous figures, such as FIGS. 6 and 7, such that the descriptions thereof are generally applicable to the corresponding components of host 800.

The memory 812 may include one or more computer programs including one or more host application programs 814 and data 816, which may include user data, e.g., data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 814 may also provide for user authentication and licensing checks and may periodically report health, routes, and content availability to a central node, such as a device in or on the edge of a core network. Accordingly, the host 800 may select and/or indicate a different host for over-the-top services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

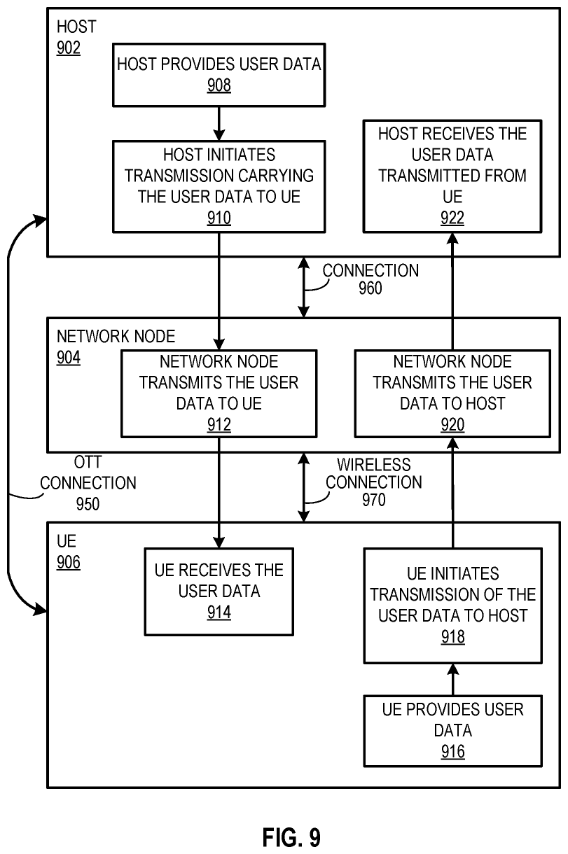

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g., such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 912 which may alternatively be used for communication between hardware nodes and radio units.

FIG. 10 shows a communication diagram of a host 1002 communicating via a network node 1004 with a UE 1006 over a partially wireless connection in accordance with some embodiments. Example implementations, in accordance with various embodiments, of the UE (such as a UE 512a of FIG. 5 and/or UE 600 of FIG. 6), network node (such as network node 510a of FIG. 5 and/or network node 700 of FIG. 7), and host (such as host 516 of FIG. 5 and/or host 800 of FIG. 8) discussed in the preceding paragraphs will now be described with reference to FIG. 10.

Like host 800, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 506 of FIG. 5) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve the data rate, latency, power consumption and thereby provide benefits such as, reduced user waiting time, relaxed restriction on file size, improved content resolution, better responsiveness, extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency, and the like, by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some embodiments of the present disclosure are described below:

Embodiment 1: A method performed by a user equipment for configuring frequency hopping via a bandwidth part framework, the method comprising: receiving a parameter with a resource block allocation for at least one frequency hop of a plurality of frequency hops; and utilizing the parameter.

Embodiment 2: The method of embodiment 1 further comprising the step of: determining a center frequency based on the parameter.

Embodiment 3: The method of any of the previous embodiments, further comprising: providing user data; and forwarding the user data to a host via the transmission to the network node.

Embodiment 4: A method performed by a network node for configuring frequency hopping via a bandwidth part framework, the method comprising: transmitting a parameter with a resource block allocation for at least one frequency hop of a plurality of frequency hops.

Embodiment 5: The method of embodiment 4, wherein the parameter accounts for a time gap between two hops.

Embodiment 6: The method of any of the previous embodiments, further comprising: obtaining user data; and forwarding the user data to a host or a user equipment.

Embodiment 7: A user equipment for configuring frequency hopping via a bandwidth part framework, comprising: processing circuitry configured to perform any of the steps of any of embodiments 1 to 3; and power supply circuitry configured to supply power to the processing circuitry.

Embodiment 8: A network node for configuring frequency hopping via a bandwidth part framework, the network node comprising: processing circuitry configured to perform any of the steps of any of embodiments 4 to 6; power supply circuitry configured to supply power to the processing circuitry.

Embodiment 9: A user equipment (UE) for configuring frequency hopping via a bandwidth part framework, the UE comprising: an antenna configured to send and receive wireless signals; radio front-end circuitry connected to the antenna and to the processing circuitry, and configured to condition signals communicated between the antenna and the processing circuitry; the processing circuitry being configured to perform any of the steps of any of the embodiments above; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 10: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of embodiments 1 to 3 to receive the user data from the host.

Embodiment 11: The host of the previous embodiment, wherein the cellular network further includes a network node configured to communicate with the UE to transmit the user data to the UE from the host.

Embodiment 12: The host of the previous 2 embodiments, wherein: the processing circuitry of the host is configured to execute a host application, thereby providing the user data; and the host application is configured to interact with a client application executing on the UE, the client application being associated with the host application.

Embodiment 13: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any embodiments 1 to 3 to receive the user data from the host.

Embodiment 14: The method of the previous embodiment, further comprising: at the host, executing a host application associated with a client application executing on the UE to receive the user data from the UE.

Embodiment 15: The method of the previous embodiment, further comprising: at the host, transmitting input data to the client application executing on the UE, the input data being provided by executing the host application wherein the user data is provided by the client application in response to the input data from the host application.

Embodiment 16: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any embodiments 1 to 3 to transmit the user data to the host.

Embodiment 17: The host of the previous embodiment, wherein the cellular network further includes a network node configured to communicate with the UE to transmit the user data from the UE to the host.

Embodiment 18: The host of the previous 2 embodiments, wherein: the processing circuitry of the host is configured to execute a host application, thereby providing the user data; and the host application is configured to interact with a client application executing on the UE, the client application being associated with the host application.

Embodiment 19: A method implemented by a host configured to operate in a communication system that further includes a network node and a user equipment (UE), the method comprising: at the host, receiving user data transmitted to the host via the network node by the UE, wherein the UE performs any of the steps of any embodiments 1 to 3 to transmit the user data to the host.

Embodiment 20: The method of the previous embodiment, further comprising: at the host, executing a host application associated with a client application executing on the UE to receive the user data from the UE.

Embodiment 21: The method of the previous embodiment, further comprising: at the host, transmitting input data to the client application executing on the UE, the input data being provided by executing the host application, wherein the user data is provided by the client application in response to the input data from the host application.

Embodiment 22: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any embodiments 4 to 6 to transmit the user data from the host to the UE.

Embodiment 23: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 24: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of embodiments 4 to 6 to transmit the user data from the host to the UE.

Embodiment 25: The method of the previous embodiment, further comprising, at the network node, transmitting the user data provided by the host for the UE.

Embodiment 26: The method of any of the previous 2 embodiments, wherein the user data is provided at the host by executing a host application that interacts with a client application executing on the UE, the client application being associated with the host application.

Embodiment 27: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any embodiments 4 to 6 to transmit the user data from the host to the UE.

Embodiment 28: The communication system of the previous embodiment, further comprising: the network node; and/or the user equipment.

Embodiment 29: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any embodiments 4 to 6 to receive the user data from a user equipment (UE) for the host.

Embodiment 30: The host of the previous 2 embodiments, wherein: the processing circuitry of the host is configured to execute a host application, thereby providing the user data; and the host application is configured to interact with a client application executing on the UE, the client application being associated with the host application.

Embodiment 31: The host of the any of the previous 2 embodiments, wherein the initiating receipt of the user data comprises requesting the user data.

Embodiment 32: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any embodiments 4 to 6 to receive the user data from the UE for the host.

Embodiment 33: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a Reduced Capability (RedCap) user equipment (UE) for configuring frequency hopping via a bandwidth part (BWP) framework, the method comprising:
receiving, from a network node, a sounding reference signal (SRS) parameter with a resource block allocation for at least one frequency hop of a plurality of frequency hops; and
performing a frequency hop based on the SRS parameter.

2. The method of claim 1, wherein a BWP of the RedCap UE (512) is a same size or smaller than a radio frequency bandwidth of the RedCap UE.

3. The method of claim 2, wherein the SRS parameter indicates a center frequency for the at least one frequency hop.

4. The method of claim 3, wherein the center frequency of the at least one frequency hop is within the BWP of the RedCap UE.

5. The method of claim 1, wherein a BWP of the RedCap UE is larger than a radio frequency bandwidth of the RedCap UE.

6. The method of claim 5, wherein the SRS parameter indicates a center frequency for the at least one frequency hop.

7. The method of claim 5, wherein a center frequency of the resource block allocation is predefined.

8. The method of claim 5, wherein a center frequency of the resource block allocation is based on an offset parameter associated with the SRS parameter.

9. The method of claim 1, wherein uplink frequency hopping and downlink frequency hopping are configured separately.

10. The method of claim 1, wherein uplink frequency hopping and downlink frequency hopping are configured together.

11. The method of claim 1, where the SRS parameter is received via at least one of Radio Resource Control (RRC) signaling, or via a Medium Access Control (MAC) entity.

12. A Reduced Capability (RedCap) user equipment (UE) configured for frequency hopping via a bandwidth part framework, the RedCap UE comprising processing circuitry configured to:
receive, from a network node, a sounding reference signal, SRS, parameter with a resource block allocation for at least one frequency hop of a plurality of frequency hops; and
perform a frequency hop based on the SRS parameter.

13. (canceled)

14. A method performed by a network node for configuring frequency hopping via a bandwidth part, BWP, framework, the method comprising
transmitting, to a Reduced Capability (RedCap) User Equipment device (UE) a sounding reference signal, SRS, parameter with a resource block allocation for at least one frequency hop of a plurality of frequency hops.

15. The method of claim 14, wherein the SRS parameter indicates a center frequency for the at least one frequency hop.

16. The method of claim 14, wherein a center frequency of the resource block allocation is based on an offset parameter associated with the SRS parameter.

17. A network node for configuring frequency hopping via a bandwidth part framework, the network node comprising processing circuitry configured to:
transmit, to a Reduced Capability (RedCap) User Equipment device (UE) a sounding reference signal, SRS, parameter with a resource block allocation for at least one frequency hop of a plurality of frequency hops.

18-20. (canceled)

21. The RedCap UE of claim 12, wherein a BWP of the RedCap UE is a same size or smaller than a radio frequency bandwidth of the RedCap UE.

22. The RedCap UE of claim 12, wherein the SRS parameter indicates a center frequency for the at least one frequency hop.

23. The network node of claim 14, wherein the SRS parameter indicates a center frequency for the at least one frequency hop.

24. The network node of claim 14, wherein a center frequency of the resource block allocation is based on an offset parameter associated with the SRS parameter.
